(19) United States
(12) Patent Application Publication
(10) Pub. No.: US 2016/0336786 A1
(43) Pub. Date: Nov. 17, 2016

(54) WIRELESS RECHARGER FOR PORTABLE DEVICE OF VEHICLE

(71) Applicants: Hyundai Motor Company, Seoul (KR); Kia Motors Corporation, Seoul (KR); DAEJOO PRECISION INDUSTRIAL CO., LTD., Hwaseong-si (KR); NIFCO KOREA Inc., Asan-si (KR)

(72) Inventors: Ki Won Kim, Seoul (KR); Won Young Bae, Seoul (KR); Youn Hwan Shin, Asan-si (KR); Kyoung Jun Jin, Hwaseong-si (KR)

(73) Assignees: Hyundai Motor Company, Seoul (KR); Kia Motors Corporation, Seoul (KR); DAEJOO PRECISION INDUSTRIAL CO., LTD., Hwaseong-si (KR); NIFCO KOREA Inc., Asan-si (KR)

(21) Appl. No.: 14/965,547

(22) Filed: Dec. 10, 2015

(30) Foreign Application Priority Data
May 11, 2015 (KR) 10-2015-0065240

(51) Int. Cl. H02J 7/02; H02J 7/00

(52) U.S. Cl. CPC H02J 7/025; H02J 7/0044

(57) ABSTRACT

A wireless recharger for a portable device of a vehicle may include a receiving case on which a wireless recharging device for recharging the portable device is mounted, a support mounted in an interior of the receiving case to be moved in an insertion direction of the portable device by the portable device inserted into the receiving case, and a movement prevention device disposed in the interior of the receiving case to resiliently press against the portable device inserted into the receiving case when the support is moved in the insertion direction of the portable device, for preventing movement of the portable device.

### CROSS-REFERENCE TO RELATED APPLICATION

The present application claims priority to Korean Patent Application No. 10-2015-0065240 filed May 11, 2015, the entire contents of which is incorporated herein for all purposes by this reference.

### BACKGROUND OF THE INVENTION

1. Field of the Invention

The present invention relates to a wireless recharger for recharging a portable device such as a smartphone. More particularly, it relates to a wireless recharger for portable device of a vehicle, which can recharge the portable device while the portable device is fixed not to be moved to stably recharge the portable device.

2. Description of Related Art

In recent years, as portable devices such as smartphones have been increasingly used, wireless rechargers for recharging portable devices have been mounted in vehicles.

FIG. 9 illustrates a vehicular wireless recharger for a smartphone according to the related art, and FIG. 10 illustrates an in-use state of the wireless recharger for a smartphone according to the related art.

As illustrated in FIGS. 9 and 10, the wireless recharger for a smartphone according to the related art performs a recharging operation while a smartphone 4 is held on the bottom surface of a tray 1 provided with a wireless recharging device 2 on a lower side thereof, and a rubber part 3 is provided on the bottom surface of the tray 1 to reduce movement of the smartphone 4 and noise that are generated while the smartphone 4 is held and recharged.

The wireless recharger for a smartphone according to the related art is configured such that the smartphone 4 is stacked on the bottom surface of the tray 1 to hold the smartphone 4 on the wireless recharging device 2, but the smartphone cannot be recharged when unintended small objects that have not be recognized by the user are positioned on the bottom surface of the tray and noise may be generated due to an unstable holding state of the smartphone. Furthermore, if the smartphone is separated from the recharging surface of the wireless recharger due to the behavior of the vehicle, a recharging error may occur according to a travel condition. For example, the smartphone may not be recharged.

In addition, when the wireless recharger for a smartphone according to the related art is manufactured, trays should be separately manufactured for various types of vehicles and rubber parts should be dually injection-molded on the bottom surfaces of the trays.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a wireless recharger for a portable device of a vehicle which can recharge the portable device while the portable device is fixedly received, thereby minimizing movement of the portable device and stably recharging the portable device during a recharging operation of the portable device.

According to various aspects of the present invention, a wireless recharger for a portable device of a vehicle may include a receiving case on which a wireless recharging device for recharging the portable device is mounted, a support mounted in an interior of the receiving case to be moved in an insertion direction of the portable device by the portable device inserted into the receiving case, and a movement prevention device disposed in the interior of the receiving case to resiliently press against the portable device inserted into the receiving case when the support is moved in the insertion direction of the portable device, for preventing movement of the portable device.

The wireless recharger may further include a push latch disposed in the interior of the receiving case, for fixedly holding the support moved in the insertion direction of the portable device.

The wireless recharger may further include a support return spring installed between the support and the receiving case to resiliently support the support, for returning the support moved in the insertion direction of the portable device with a resilient restoring force.

The movement prevention device may include a movement prevention guide disposed on an upper side of the support and installed in the receiving case to be rotatable with respect to a hinge, and a guide spring disposed between the hinge and the movement prevention guide while being compressed, for rotating the movement prevention guide with the resilient restoring force to resiliently press against the portable device when the support is moved in the insertion direction of the portable device.

A roller having a circular cross-section may be rotatably disposed on one side of the movement prevention guide.

A linear guide rib having a plurality of teeth may be provided at an inner upper end of the receiving case, and a guide gear engaged with the guide rib to be rotatable may be provided at an upper end of the support.

The wireless recharger for a portable device of a vehicle according to the present invention minimizes movement of the portable device during a recharging operation of the portable device to stably recharge the portable device and prevents generation of noise due to movement of the portable device. In addition, the portable device may be received in the wireless recharger in a slot type such that it increases use efficiency of the consumer, improves emotion quality, and secures a separate space for wireless recharging, thereby improving packaging quality.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a tray on which an exemplary wireless recharger for a portable device according to the present invention is mounted.

FIG. 2A and FIG. 2B are views illustrating the exemplary wireless recharger for a portable device according to the present invention.

FIG. 3 is a sectional view taken along line A-A of FIG. 1

FIG. 4 is a sectional view taken along line B-B of FIG. 1.

FIG. 5 is an exploded perspective view illustrating a main part of the exemplary wireless recharger for a portable device according to the present invention.

FIG. 6 is a perspective view illustrating an assembled state of elements of FIG. 5.

FIG. 7 is a view illustrating a process of inserting a portable device into the exemplary wireless recharger for a portable device according to the present invention.

FIG. 8A and FIG. 8B are views illustrating a process of compulsorily extracting a portable device from the exemplary wireless recharger for a portable device and inserting the portable device again according to the present invention.

FIG. 9 is a view illustrating a vehicular wireless recharger for a smartphone according to the related art.

FIG. 10 is a view illustrating an in-use state of the wireless recharger for a smartphone according to the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

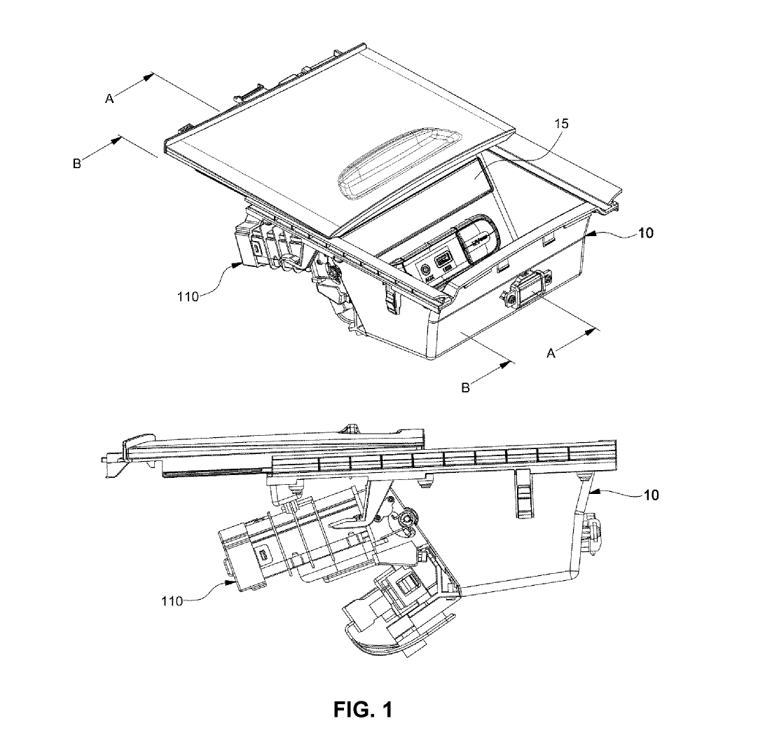

As illustrated in FIGS. 1 to 4, a wireless recharger for a portable device according to the present invention is configured to push (or press and insert) a portable device into a receiving case 110 on which a wireless recharging device 123 for wirelessly recharging the portable device is mounted in order to charge the portable device, and includes a support 130 and a movement prevention device 140 that operates in association with operations of the support 130 to improve positioning efficiency of the portable device held on the wireless recharging device 120 in the receiving case 110 and improve in-use efficiency of the user.

The receiving case 110 is mounted to a rear lower side of the tray 10 mounted on the interior of the vehicle and an interior receiving space S is defined by an upper case at an upper end thereof, a lower case 112 at a lower end thereof, a front case 113 at a front end thereof, and a rear case 114 at a rear end thereof, which are connected to each other in an assembled manner. An entrance 113a for inserting and extracting the portable device is provided on a front surface (one side of the front case) that faces a front side space of the tray 1.

That is, the receiving space S connected to the entrance 113a is formed in the interior of the receiving case 110, and the portable device inserted through the entrance 113a is positioned on the wireless charging device 120 on the lower side of the receiving space S.

The bottom (lower case) of the receiving case 110 has a recessed structure corresponding to the external appearance of the wireless recharging device 120 to accommodate (contain) the wireless recharging device 120, and accordingly, an upper surface of the wireless recharging device 120 fixedly mounted on the recessed part of the receiving case 110 is adjacent to a flat part of the receiving case 110 while being parallel to the flat part of the receiving case 110 such that the portable device may be positioned.

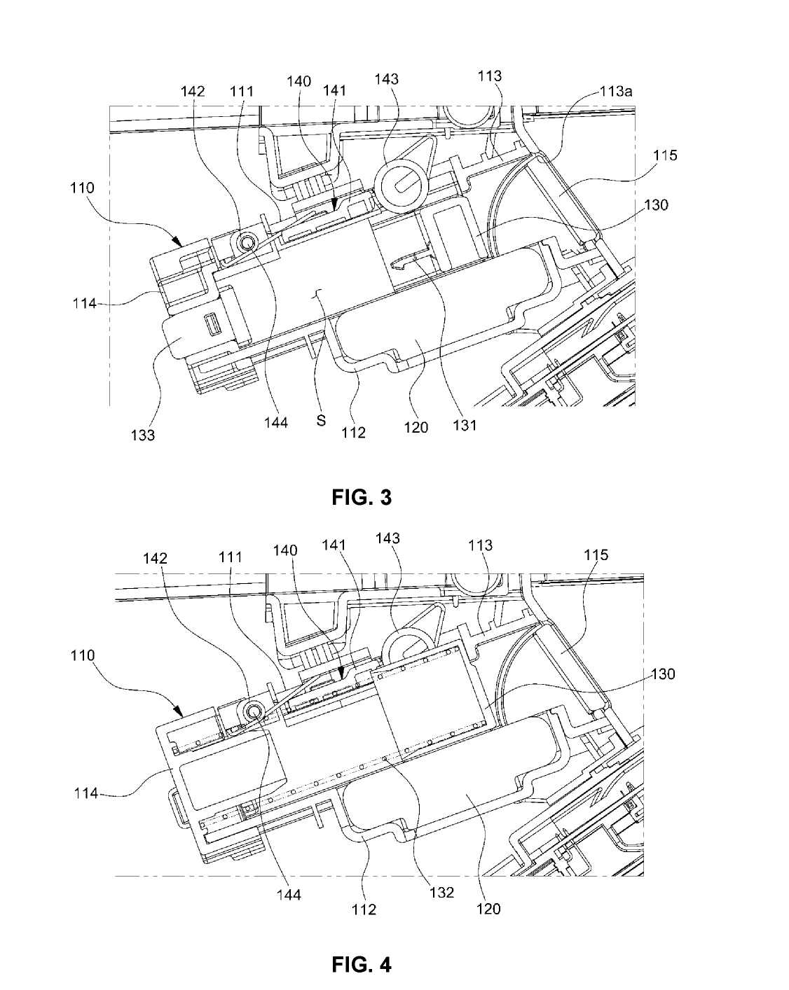

As illustrated in FIGS. 3 and 4, the support 130 is installed within the receiving case 110 such that it is pushed by the portable device inserted into the receiving case 110 above the wireless recharging device 120 to be moved in the insertion direction of the portable device, and is resiliently supported by a pair of support return springs 132 installed between the support 130 and the receiving case 110 to resiliently support one end of the portable device inserted into the receiving case 110.

The support 130 compresses the support return spring 132 while being moved in the insertion direction of the portable device, and is moved by a resilient restoring force of the support return spring 132 when returning to the original position after being moved in a direction opposite to the insertion direction of the portable device.

Then, in order to prevent the portable device from being extracted to the outside of the receiving case 110 by the support return spring 132 and the support 130 regardless of the intention of the user, a push latch 133 for fixedly holding the support 130 (such that the support 130 may not be moved) is mounted in the interior of the receiving case 110.

The push latch 133 is disposed on the rear side of the support 130 to hold and fix the support 130 moved in the insertion direction of the portable device such that the support 130 does not return to the original position, and is installed at a central portion of the rear case 114 and has a locking structure (or hooking structure) for holding and fixing a stopper 131 protruding from a rear end of the support 130 to prevent the support 130 from being moved forwards to return to the original position.

The push latch 133 may be a general latch device including a locking function for holding and fixing the stopper 131 that enters the interior of the push latch 133 when the support 130 is moved rearwards, and an unlocking function for unlocking the stopper 131 when the locked stopper 131 is slightly moved rearwards to return the support 130.

Although not illustrated, the push latch 133 prevents forward movement of the support 130 for return as the stopper 131 of the support 130 moved rearwards in the insertion direction of the portable device is inserted and locked, and returns the support 130 as the support 130 is further moved in the insertion direction of the portable device to unlock the stopper 131 (release the stopped state of the stopper 131).

The support 130 supports the portable device inserted into the receiving case 110 together with the movement prevention device 140 to position the portable device on the wireless recharging device 120.

The movement prevention device 140 is disposed in the interior of the receiving case 110 on the upper side of the support 130, and functions to resiliently press the portable device inserted into the receiving case 110 when the support 130 is moved rearwards in the insertion direction of the portable device to prevent movement of the portable device.

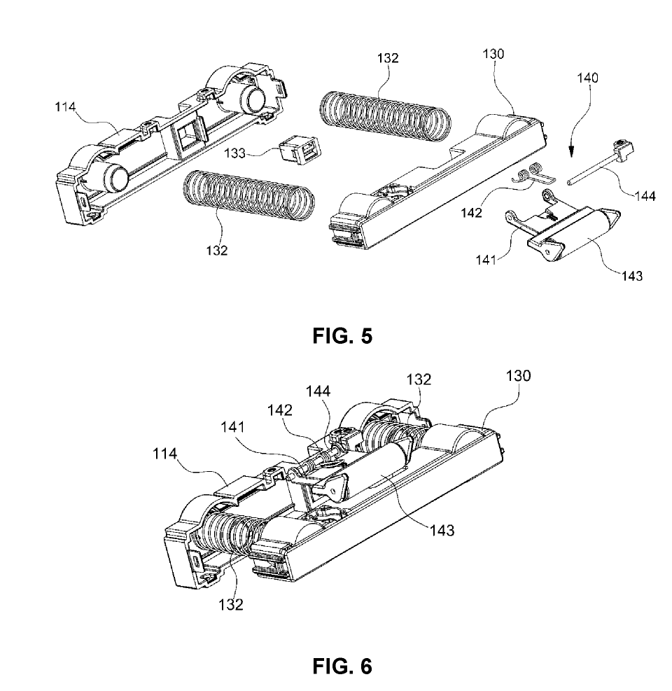

As illustrated in FIGS. 5 and 6, the movement prevention device 140 includes a movement prevention guide 141, a guide spring 142, and a roller 143 such that movement of the portable device can be prevented by resiliently pressing the portable device.

The movement prevention guide 141 is installed to be rotated about a hinge 144 installed within the receiving case 110 and is disposed on the upper side of the support 130, and a guide spring 142 for resiliently supporting the movement prevention guide 141 is installed between the hinge 144 and the movement prevention guide 141. The guide spring 142 resiliently supports the movement prevention guide 141 while the portable device is compressed before the portable device is inserted into the receiving case 110.

The roller 143 is rotatably assembled at one side of the movement prevention guide 141 (a part in contact with the support and the portable device), and has a circular cross-section such that it is smoothly rotated when contacting the support 130 and the portable device.

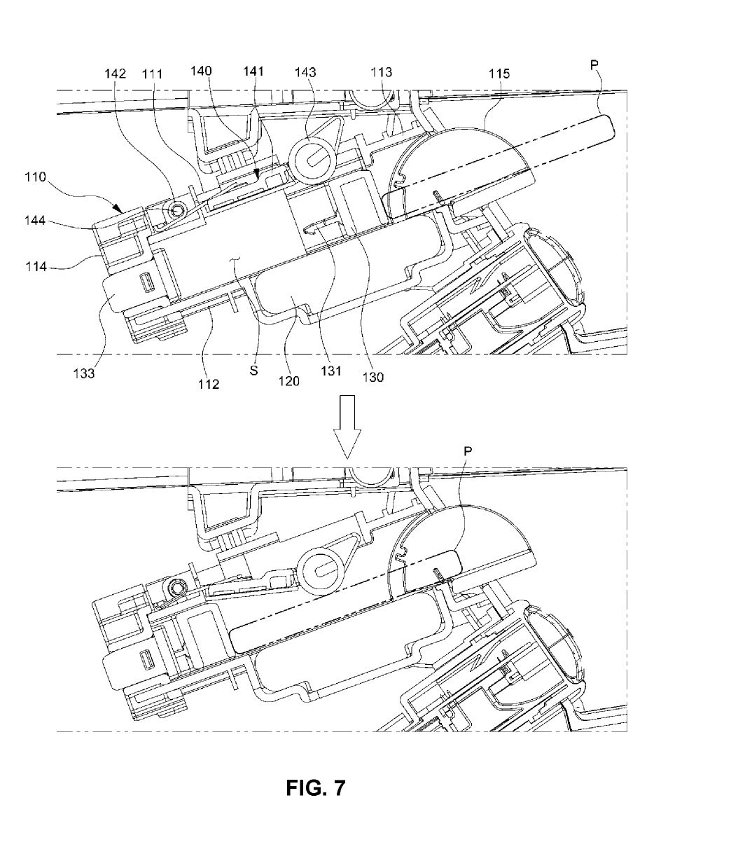

As illustrated in FIG. 7, the roller 143 is held (or supported) on one side of the support 130 before the portable device P is inserted into the receiving case 110, and accordingly, is rotated while contacting the support 130 moved rearwards when the portable device P is inserted into the receiving case 110 such movement of the support 130 is not interfered and is rotated while contacting an upper end surface of the portable device P inserted by a pushing force of the user such that insertion of the portable device P is not hampered.

When the portable device P is inserted into the receiving case 110 and the support 130 is pushed and moved rearwards, the movement prevention device 140 prevents movement of the portable device P and positions the portable device P on the wireless recharging device 120 as the movement prevention guide 141 is rotated towards the portable device to push and press the portable device P towards the wireless recharging device 120, by a resilient restoring force of the guide spring 142 that is compressed before the portable device P is inserted into the receiving case 110.

Although not illustrated in the drawings, when the portable device P is extracted, if the push latch 133 is unlocked by further pushing the portable device P in the insertion direction of the portable device P and accordingly further moving the support 130 in the insertion direction of the portable device P, the support 130 pushes the portable device to extract the portable device while returning to the original position with a resilient restoring force of the support return spring 132.

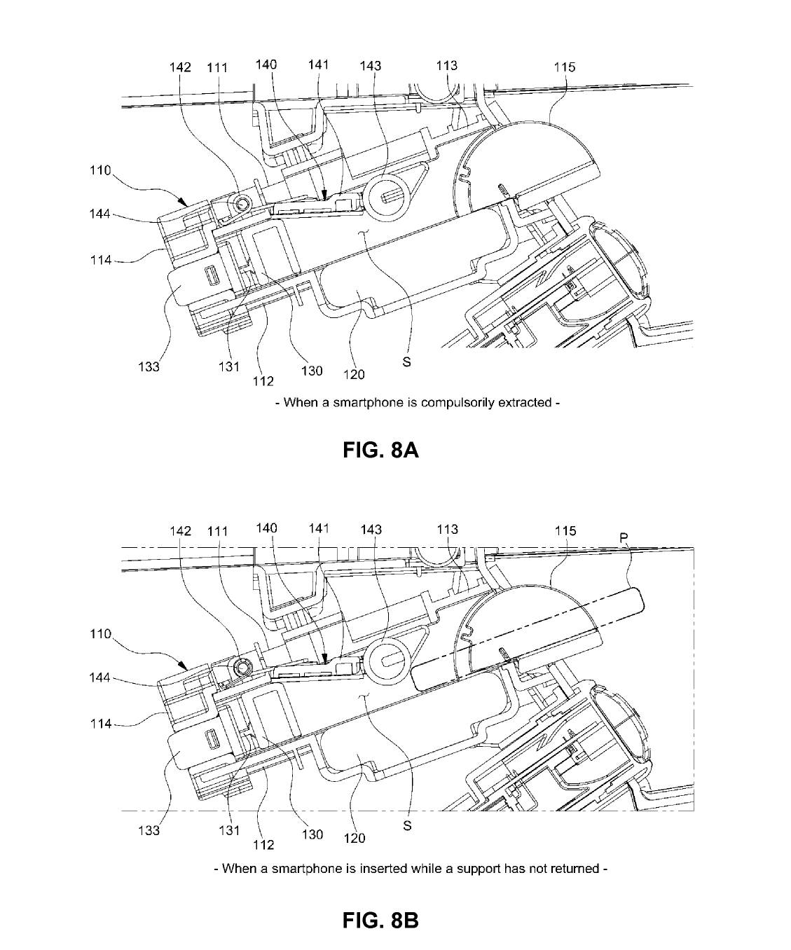

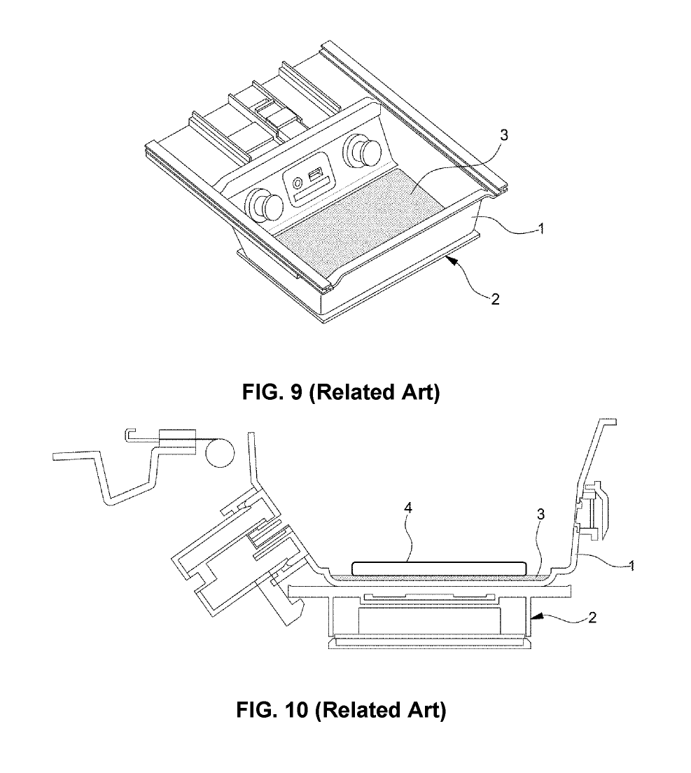

However, when the user compulsorily extracts the portable device P, the locked state of the push latch 133 is not released so that the support 130 cannot be moved forwards to return as illustrated in FIG. 8A and FIG. 8B.

When the support 130 moved rearwards in the insertion direction of the portable device P has not returned, the portable device inserted into the receiving case 110 can be prevented from entering the interior of the receiving case 110 because the movement prevention device 140 also has not returned, but the portable device can be easily inserted into the receiving case 110 by the roller 143 provided on one side (a part in contact with the support and the portable device) of the movement prevention guide 141. Then, the roller 143 is pushed and rotated by the portable device inserted into the receiving case 110 and is raised (lifted).

To this end, when the movement prevention device 140 has not returned, the height from the wireless recharging device 120 to the center of the roller 143 is set to be larger than the thickness of the portable device.

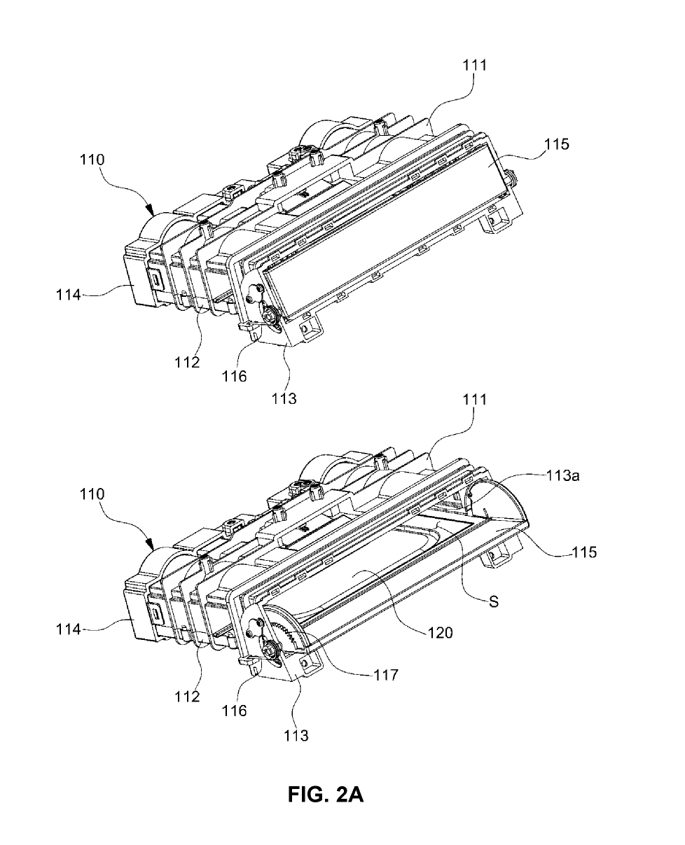

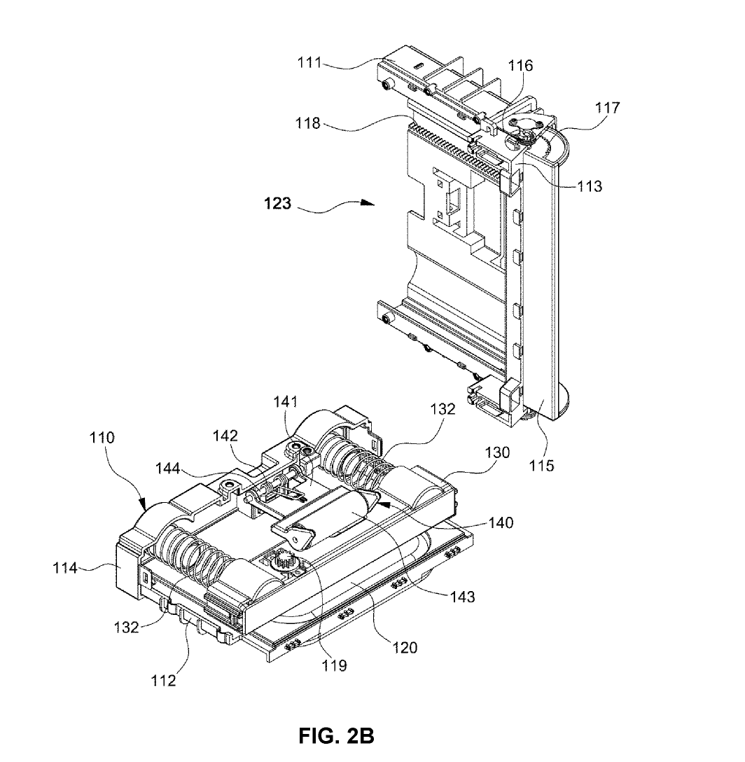

Furthermore, as illustrated in FIG. 2A, in order to prevent the support 130 unlocked by the push latch 133 from being abruptly moved forwards to suddenly push the portable device out and secure fluidity, a linear guide rib 118 having a plurality of teeth arranged in a lengthwise direction thereof is provided at an inner upper end of the receiving case 110 and a guide gear 119 engaged (enmeshed) with the guide gear 118 to be rotated is provided at an upper end of the support 130.

The guide rib 118 has a general rack gear shape, and the guide gear 119 has a general pinion gear shape.

In addition, in order to receive and recharge portable devices having various sizes (thicknesses), it is preferable that the rotation angle of the movement prevention guide 141 rotated by a resilient restoring force of the guide spring 142 is maximum.

Meanwhile, as illustrated in FIGS. 2A and 2B, the push cover 115 provided at a front end (one side of the front case) of the receiving case 110 may be opened and closed in a push open type.

The push cover 115 is opened by a resilient restoring force of the spring member 116 installed between the front case 111 and the push cover 115 when being unlocked in a push manner, and is prevented from being abruptly opened by a gear device 117 formed on a side surface thereof and secures fluidity such that it may be smoothly opened.

The push cover 115 is rotated to the lower side and protrudes to the front side of the entrance 113a to support the portable device extracted when the entrance 113a of the receiving case 110 is opened, to prevent the portable device from falling down and improve convenience when the portable device is extracted.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A wireless recharger for a portable device of a vehicle, comprising:
a receiving case on which a wireless recharging device for recharging the portable device is mounted;
a support mounted in an interior of the receiving case to be moved in an insertion direction of the portable device by the portable device inserted into the receiving case; and
a movement prevention device disposed in the interior of the receiving case to resiliently press against the portable device inserted into the receiving case when the support is moved in the insertion direction of the portable device, for preventing movement of the portable device.

2. The wireless recharger of claim 1, further comprising a push latch disposed in the interior of the receiving case, for fixedly holding the support moved in the insertion direction of the portable device.

3. The wireless recharger of claim 1, further comprising a support return spring installed between the support and the receiving case to resiliently support the support, for returning the support moved in the insertion direction of the portable device with a resilient restoring force.

4. The wireless recharger of claim 1, wherein the movement prevention device comprises:
a movement prevention guide disposed on an upper side of the support and installed in the receiving case to be rotatable with respect to a hinge; and
a guide spring disposed between the hinge and the movement prevention guide while being compressed, for rotating the movement prevention guide with the resilient restoring force to resiliently press against the portable device when the support is moved in the insertion direction of the portable device.

5. The wireless recharger of claim 4, wherein a roller having a circular cross-section is rotatably disposed on one side of the movement prevention guide.

6. The wireless recharger of claim 1, wherein a linear guide rib having a plurality of teeth is provided at an inner upper end of the receiving case, and a guide gear engaged with the guide rib to be rotatable is provided at an upper end of the support.
